(19) United States
(12) Patent Application Publication
(10) Pub. No.: US 2026/0318495 A1
(43) Pub. Date: Oct. 15, 2026

(54) HEADLAMP SYSTEM FOR A MOTOR VEHICLE AND MOTOR VEHICLE WITH SUCH A HEADLAMP SYSTEM

(71) Applicant: HELLA GMBH & CO. KGAA, Lippstadt (DE)

(72) Inventors: Mathias Drüppel, Bad Wünnenberg (DE); Bernd Fischer, Altenbeken (DE); Julian Grote, Borchen (DE); Lukas Hiller, Lippstadt (DE); Marc Kaup, Paderborn (DE); Susanne Köhler, Lippstadt (DE); Christian Schmidt, Paderborn (DE); David Schulz, Dortmund (DE)

(21) Appl. No.: 19/647,024

(22) Filed: Apr. 14, 2026

(30) Foreign Application Priority Data
Apr. 15, 2025 (DE) 102025114685.3

(51) Int. Cl. F21S 41/657; B60Q 1/06; B60Q 1/14; F21S 41/50

(52) U.S. Cl. CPC F21S 41/657; B60Q 1/06; B60Q 1/1407; F21S 41/50; B60Q 2200/30

(57) ABSTRACT

The invention relates to a headlamp system. The headlamp system includes a headlamp having a housing with a receiving space for functional components, and a cover lens arranged on the housing and closing a front side of the receiving space. A light module is arranged in the receiving space and includes an activatable light source and an optical system. A cover frame is arranged in a fixed position within the receiving space. A pivotable support frame is also provided, with at least the optical system secured thereto. The support frame is mounted in the housing so as to be pivotable about a pivot axis to move at least the optical system between a first end position and a second end position. In the first end position, a light exit surface of the optical system is positioned within a region covered by the cover frame and is concealed from external view.

### CROSS-REFERENCE TO RELATED APPLICATIONS

This application claims the benefit of German Patent Application 10-2025-114-685.3, filed Apr. 15, 2025, the disclosure of which is incorporated by reference in its entirety.

### FIELD OF THE INVENTION

The invention relates to a headlamp system for a motor vehicle. The invention further relates to a motor vehicle with such a headlamp system.

### BACKGROUND OF THE INVENTION

In the case of motor vehicles, the external appearance of the motor vehicle is an important design aspect for creating individuality and brand identity. However, the artistic or aesthetic design of a motor vehicle component must not impair the functionality of the motor vehicle component, or an artistic or aesthetic design of the motor vehicle component must take into account the function of the motor vehicle component. In the case of headlamps, a light exit through the cover lens must be as unobstructed as possible. For this reason, cover lenses are usually transparent. However, this has the disadvantage that the inside of the headlamp can be seen from the outside through the cover lens, which is generally undesirable from an aesthetic point of view when the headlamps are switched off. For this reason, vehicle designers often aim for a headlamp design that is referred to as “hidden until lit.” This means in particular that the functional component, for example, a low beam module, only becomes visible when it is active.

It is known from DE 10 2021 119 165 A1 that a lamp of a motor vehicle has a transparent or translucent light exit surface, wherein the transparent or translucent light exit surface is formed by a light exit wall of the lamp or the outer skin of the vehicle, which is provided with at least one electrochromic layer with opaque floating particles and which can be switched electrically, at least in certain areas, between an opaque state and a transparent or translucent state by means of electrical energy supplied by an electrical voltage source.

The disadvantage of such a solution is that the light exit surface is not 100% opaque in the opaque state and is not 100% translucent in the transparent or translucent state.

DE 10 2012 108 772 B4 discloses an operable cover for functional parts of a headlamp for a motor vehicle. A lighting device for a vehicle is known from DE 10 2023 117 612 A1, wherein a light rotation part can rotate a light connection part so that a light generation part emits light to a driving lens unit or to a radiator grille lens unit in order to selectively realize driving lighting or radiator grille lighting using the same light generation part. DE 10 2021 102 631 B4 discloses further prior art.

### SUMMARY OF THE INVENTION

The object of the present invention is to provide a novel design of a headlamp system that enables “hidden until lit” functionality. This object is achieved by the subject matter disclosed herein.

The headlamp system according to the invention is a headlamp system for a motor vehicle. The headlamp system comprises at least one headlamp. The headlamp is, in particular, a front headlamp of the motor vehicle.

The headlamp has a housing with a receiving space for functional components of the headlamp. The functional components may be, for example, light sources, electronic components, cooling devices, etc. The headlamp further has a cover lens arranged on the housing, which closes off the receiving space on the front side. The cover lens is preferably configured to be transparent. Furthermore, the headlamp comprises a light module with an activatable light source arranged in the receiving space. Light is emitted by the light source in an activated state. In a deactivated state, the light source preferably emits no light. In principle, however, it is also conceivable that in an activated state, light is emitted with a significantly reduced intensity compared to the activated state.

The light module has an optical system. The optical system may, for example, have one or more lenses and/or one or more mirrors. The optical system is designed to shape the light emitted by the light source in such a manner and to radiate it via a light exit surface in the direction of the cover lens in such a way that a desired light distribution is generated in the exterior space in front of the motor vehicle. The headlamp further comprises a cover frame, wherein the cover frame is arranged in a fixed position in the receiving space. Furthermore, the headlamp comprises a pivotable, in particular foldable, support frame, wherein at least the optical system is fastened in the support frame. This means that at least the optical system can be pivoted by pivoting the support frame, namely, transferred from a first end position to a second end position and vice versa. In the first end position, the light exit surface is arranged in a region covered by the cover frame to prevent it from being seen from the outside, and in the second end position, the light exit surface is arranged outside the region covered by the cover frame to prevent it from being seen from the outside. In other words, the light exit surface is concealed by the cover frame in the first end position so that the light exit surface is not visible from the outside. In this first end position, however, the light exit surface cannot emit any light in the direction of the cover lens in order to generate the desired light distribution in the exterior space in front of the vehicle. However, this is possible in the second end position. Furthermore, the headlamp comprises a drive, wherein the drive is set up to pivot the support frame about the pivot axis. The drive may be, for example, an electric motor.

The headlamp system can be operated in a first operating mode and in a second operating mode, or has a first operating mode and a second operating mode. In the first operating mode, the light source is deactivated, and the support frame is moved to the first end position. In the second operating mode, the light source is activated, and the support frame is moved to the second end position.

Thus, in the first operating mode, in which the light source is deactivated, the light exit surface is covered by the cover frame, whereas in the second operating mode, the light source is activated and the light exit surface is not covered by the cover frame. This creates a “hidden until lit” design of the headlamp in relation to the light module.

It is considered particularly advantageous if the cover frame is completely opaque. In principle, however, it is also conceivable that the cover frame is translucent but not transparent, in particular in view of aesthetic aspects.

Preferably, the angular difference between the first end position and the second end position is at least 10° in absolute value. Preferably, the angular difference between the first end position and the second end position is at most 70° in absolute value.

It is entirely conceivable that the support frame is formed by a housing of the light module.

It is considered to be particularly advantageous if the headlamp system has a headlamp controller, wherein the headlamp controller is set up to actuate the light module and the drive in such a way that, when changing to the first operating mode, the light source is deactivated and the support frame is transferred to the first end position, and when changing to the second operating mode, the light source is activated and the support frame is transferred to the second end position. The headlamp controller can be implemented as a software function in a control module of the motor vehicle.

In principle, it is conceivable that the light source is arranged in a fixed position in the housing. The optical system may be, for example, a mirror that is held or fastened in the support frame so that the mirror can be folded open and folded closed by pivoting from the first end position to the second end position.

It is considered particularly advantageous if the entire light module is fastened in the support frame.

It is considered particularly advantageous if the optical system is arranged fixed relative to the light source of the light module.

It is considered to be particularly advantageous if the cover frame has an interruption in the pivoting region of at least the optical system, wherein a cover panel is connected to the support frame or the light module forms a cover panel, wherein the cover panel is designed in such a way that the cover panel covers the interruption in the first end position.

In particular, in such an embodiment, it is considered advantageous if a surface of the cover panel that is visible from the outside in the first end position is matched to a surface of the cover frame that is visible from the outside.

It is considered particularly advantageous if the light module is a high beam module and/or low beam module for generating a high beam light distribution and/or low beam light distribution in the exterior space in front of the motor vehicle in the second operating mode.

In a preferred embodiment, it is provided that the pivot axis runs parallel or substantially parallel to a transverse direction of the motor vehicle when the headlamp is mounted in the vehicle. For the purposes of the present disclosure, substantially parallel means in particular that an angular deviation of the pivot axis relative to the transverse direction of the vehicle is less than 5°.

Such an embodiment with a pivot axis aligned parallel or substantially parallel to the transverse direction of the vehicle and thus substantially horizontally aligned brings to mind pop-up headlamps, as were often provided in the past, in particular in sports cars. Therefore, such a design appeals in particular to people who value a sporty design.

A further advantage of a pivot axis aligned parallel or substantially parallel to the longitudinal direction of the vehicle is that dazzling of road users located to the side of the motor vehicle when the operating mode is changed is avoided.

In principle, it is conceivable that the activating and/or deactivating and the pivoting of the support frame can overlap in time when the operating mode is changed, in particular occur simultaneously. However, it is also conceivable that the activating and/or deactivating and the pivoting of the support frame occur in a time-staggered manner when the operating mode is changed, in particular such that, during a change to the second operating mode, pivoting is performed first and activation is performed thereafter, and during a change to the first operating mode, deactivation is performed first and pivoting is performed thereafter.

A further advantage of a pivot axis aligned parallel or substantially parallel to the longitudinal direction of the vehicle is that the same drive can also be used for adjusting the beam width of the light distribution. In this context in particular, it is considered advantageous if the second end position is variable in order to enable headlamp leveling of the light distribution. For example, it is conceivable that the headlamp system is set up to store a change in the angular position made from the second end position for the purpose of headlamp leveling and to store the angular position changed relative to the second end position as a new second end position so that the drive moves to the new second end position when changing again from the first operating mode to the second operating mode.

It is considered particularly advantageous if, when the headlamp is mounted in the motor vehicle, the light exit surface is positioned higher in the second end position in the vertical direction of the vehicle than in the first end position.

It is considered to be particularly advantageous if an additional light module having an additional activatable light source and having an additional optical system is fastened in the same support frame, wherein light is emitted by the additional light source in an activated state of the additional light source, wherein the additional optical system is set up to shape the light emitted by the additional light source and to radiate it in the direction of the cover lens via an additional light exit surface such that an additional desired light distribution is generated in the exterior space in front of the motor vehicle, wherein in the second end position, the additional light exit surface is arranged in the region covered by the cover frame against views from the outside, and in the first end position, the additional light exit surface is arranged outside the region covered by the cover frame against views from the outside.

The additional light module may, for example, be a daytime running light module. In particular, if the light module is a high beam module and/or a low beam module, it is not necessary for the daytime running light module to be active in the second operating mode. It is therefore considered particularly advantageous if the additional light source is activated in the first operating mode, in particular if the additional light source is deactivated in the second operating mode.

It is considered particularly advantageous if the additional light module is arranged above the light module in the vertical direction of the vehicle, in particular if it is fastened to an upper side of the light module.

In a particularly preferred embodiment, it is provided that the cover frame has a light exit window, wherein in the first end position the additional light exit surface is positioned in the light exit window, and in the second end position the light exit surface is positioned in the light exit window. In other words, the same light exit window is used by the light module and the additional light module. As a result, a similar appearance of the motor vehicle can be achieved both when the light module is active and when the additional light module is active, in particular in the case of daytime running light, and low beam and/or high beam.

The motor vehicle according to the invention has the headlamp system according to the invention. Therefore, the explanations regarding the advantages and advantageous embodiments of the headlamp system apply accordingly to the motor vehicle, and vice versa.

### BRIEF DESCRIPTION OF THE DRAWINGS

The invention is explained in more detail in the following figures on the basis of exemplary embodiments without being limited thereto. In the drawings:

FIG. 1 is a front view of a motor vehicle;

FIG. 2 is a headlamp of the motor vehicle according to a first embodiment in a schematic representation in a first operating mode;

FIG. 3 is the headlamp according to FIG. 2 in a second operating mode;

FIG. 4 is a headlamp of the motor vehicle according to a second embodiment in a schematic representation in a first operating mode; and

FIG. 5 is the headlamp according to FIG. 4 in a second operating mode.

### DETAILED DESCRIPTION

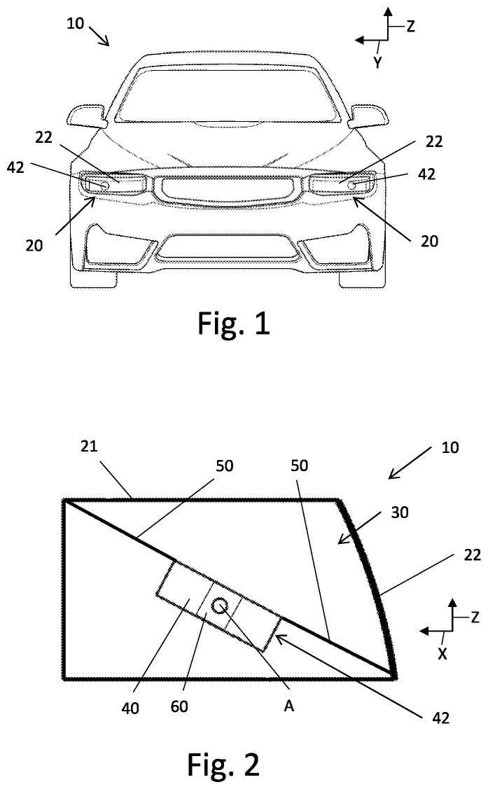

FIG. 1 shows a motor vehicle 10 in a front view, i.e., in a view from the front. In the figures, the vehicle vertical direction is indicated by an arrow Z, the vehicle transverse direction is indicated by an arrow Y, and the vehicle longitudinal direction is indicated by an arrow X.

The motor vehicle 10 has a headlamp system, wherein the headlamp system comprises two headlamps 20, wherein the headlamps 20 in the present case are front headlamps of the motor vehicle 10. The headlamp system also comprises a headlamp controller for actuating functional components of the headlamps 20. The headlamps 20 are mirror-symmetrical to each other and otherwise substantially identical in design, so that only one of the headlamps 20 and its functional components will be described in more detail below. The explanations apply accordingly to the other headlamp 20.

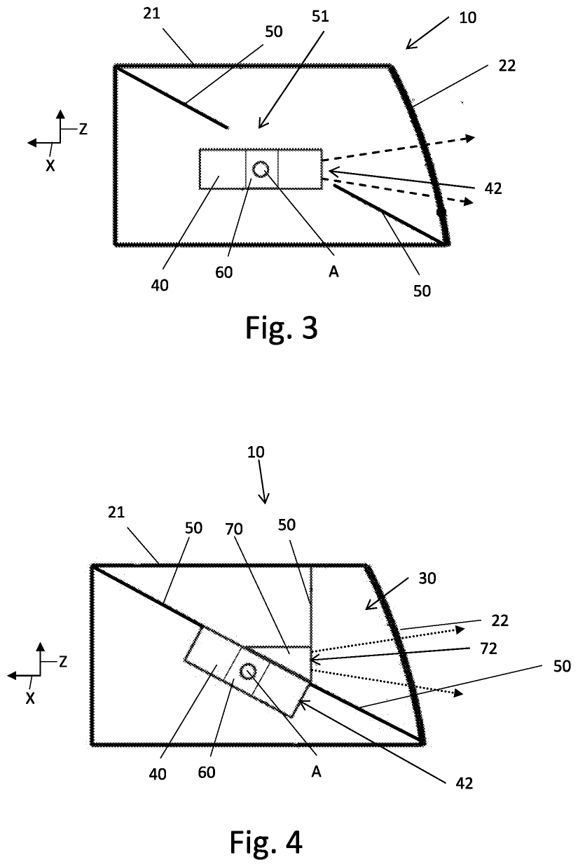

The headlamp 20 according to a first embodiment is shown schematically in FIG. 2 and FIG. 3. FIG. 2 and FIG. 3 show the headlamp 20 in different operating modes, wherein FIG. 2 shows the headlamp 20 in a first operating mode, and FIG. 3 shows the headlamp 20 in a second operating mode. The differences between the first and second operating modes are explained in more detail below.

The headlamp 20 has a housing 21 having a receiving space 30 for functional components of the headlamp 20. The front of the housing 21 is closed by a transparent or at least partially transparent cover lens 22. The cover lens 22 is in particular a cover lens made of plastic. A light module 40 is arranged in the receiving space 30, wherein the light module 40 has at least one light source that can be activated. The at least one activatable light source may be an LED, for example. The light module 40 in this case is a low beam module. However, the light module may also be a high beam module or a combined low beam and high beam module. The at least one activatable light source is set up to emit light in the activated state of the light source. In the case of a combined low beam and high beam module, it is basically conceivable that the light source has a first activated state that is assigned to the low beam and a second activated state that is assigned to the high beam. In a deactivated state of the light source, no light is emitted by the light source. The light module 40 has an optical system that is set up to shape the light emitted by the light source and to radiate the light via a light exit surface 42 in the direction of the cover lens 22 in such a way that a desired light distribution is generated in the exterior space in front of the motor vehicle 10.

The headlamp 20 has a cover frame 50, wherein the cover frame 50 is arranged in a fixed position in the receiving space 30. In the present case, the cover frame 50 extends in a side view through the receiving space 30 from the front bottom to the rear top. As a result, in the direction of travel or longitudinal direction of the vehicle, partial regions of the receiving space 30 are covered on the front by the cover frame 50 for an outside observer.

The headlamp 20 also has a pivotable support frame 60, wherein the light module 40 is fastened in the support frame 60. The support frame 60 is mounted pivotably in the housing 21 about a pivot axis A running substantially horizontally and parallel to the vehicle transverse direction Y. This allows the light module 40 to be pivoted from a first end position, which is shown in FIG. 2, to a second end position, which is shown in FIG. 3.

As can be seen in particular from FIG. 2, in the first end position, the light exit surface 42 is arranged in the region covered by the cover frame 50 against views from the outside, namely pivoted behind a front section of the cover frame 50 and thus covered by the front section.

In the second end position, however, the light exit surface 42 is arranged outside the region covered by the cover frame 50 against views from the outside, namely pivoted upward over the front section of the cover frame 50. For pivoting the support frame 60 about the pivot axis A, the headlamp 20 has a drive that is not shown in detail.

It is intended that in the first operating mode, shown in FIG. 2, the light source is deactivated and the support frame 60 is transferred to the first end position, whereas in the second operating mode, shown in FIG. 3, the light source is activated and the support frame 60 is transferred to the second end position. This results in a “hidden until lit” design of the headlamp 20.

In the present case, the cover frame 50 has an interruption 51 in the pivoting region of the light module 40, wherein the light module 40 forms a cover panel, wherein the cover panel is designed in such a way that the cover panel covers the interruption 51 in the first end position, namely, closes flush with it. It is provided that a surface of the cover panel that is visible from the outside in the first end position is matched to a surface of the cover frame 50 that is visible from the outside.

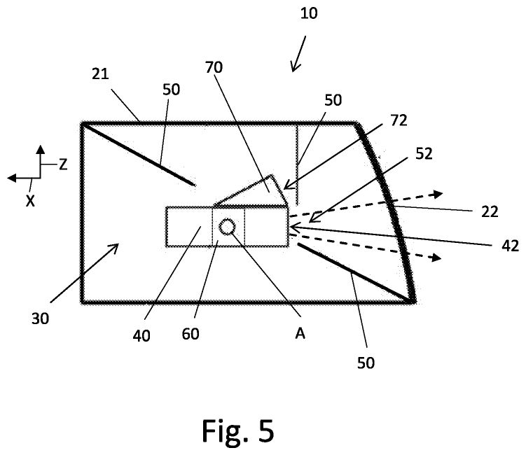

FIG. 4 and FIG. 5 show a second embodiment of the headlamp 20, wherein FIG. 4 shows the headlamp 20 in the first operating mode and FIG. 5 shows the headlamp 20 in the second operating mode.

The headlamp 20 of the second embodiment differs substantially from the headlamp 20 of the first embodiment in that the headlamp 20 has an additional light module 70 with an additional activatable light source and with an additional optical system, wherein light is emitted by the additional light source in an activated state of the additional light source, wherein the additional optical system is set up to shape the light emitted by the additional light source and to radiate the light via an additional light exit surface 72 in the direction of the cover lens 22 in such a way that an additional desired light distribution is generated in the exterior space in front of the motor vehicle 10. In the present case, the additional light module 70 is a daytime running light module.

The additional light module 70 is arranged above the light module 40 in the vehicle vertical direction Z and is fastened to it. The cover frame 50 has a light exit window 52, wherein in the first end position the additional light exit surface 72 is positioned in the light exit window 52, and in the second end position the light exit surface 42 is positioned in the light exit window 52. In this case, the cover frame 50 or the light exit window 52 is designed in such a way that, in the second end position, the additional light exit surface 72 is arranged in the region covered by the cover frame 50 against views from the outside.

### List of Reference Symbols

10 motor vehicle
20 headlamp
21 housing
22 cover lens
30 receiving space
40 light module
42 light exit surface
50 cover frame
51 interruption
52 light exit window
60 support frame
70 additional light module
72 additional light exit surface
A pivot axis
X vehicle longitudinal direction
Y vehicle transverse direction
Z vehicle vertical direction

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A headlamp system for a motor vehicle, comprising:
at least one headlamp including:
a housing defining a receiving space for functional components;
a cover lens arranged on the housing and closing a front side of the receiving space;
a light module arranged in the receiving space and including a light source and an optical system, the light source being activatable to emit light, and the optical system being configured to shape the emitted light and direct the light via a light exit surface toward the cover lens to produce a desired light distribution in an exterior space in front of the motor vehicle;
a cover frame arranged in a fixed position within the receiving space;
a support frame supporting at least the optical system, the support frame being mounted in the housing so as to be pivotable about a pivot axis to move at least the optical system between a first end position and a second end position, wherein in the first end position the light exit surface is positioned within a region covered by the cover frame and is concealed from external view, and in the second end position the light exit surface is positioned outside the region covered by the cover frame and is visible from outside; and
a drive configured to pivot the support frame about the pivot axis;
wherein the headlamp system has a first operating mode and a second operating mode, wherein in the first operating mode the light source is deactivated and the support frame is in the first end position, and wherein in the second operating mode the light source is activated and the support frame is in the second end position.

2. The headlamp system of claim 1, further comprising a headlamp controller configured to actuate the light module and the drive such that, when changing to the first operating mode, the light source is deactivated and the support frame is moved to the first end position, and when changing to the second operating mode, the light source is activated and the support frame is moved to the second end position.

3. The headlamp system of claim 1, wherein when changing to the second operating mode, the support frame is first moved to the second end position and the light source is then activated, and when changing to the first operating mode, the light source is first deactivated and the support frame is then moved to the first end position.

4. The headlamp system of claim 1, wherein the light module is fastened in the support frame.

5. The headlamp system of claim 1, wherein the cover frame includes an interruption in a pivoting region of at least the optical system, and wherein a cover panel is connected to the support frame or is formed by the light module, the cover panel being configured to cover the interruption in the first end position.

6. The headlamp system of claim 1, wherein the light module is configured as a high beam module, a low beam module, or both, for generating a corresponding light distribution in the second operating mode.

7. The headlamp system of claim 1, wherein the pivot axis extends parallel or substantially parallel to a transverse direction of the motor vehicle when the headlamp is mounted in the motor vehicle.

8. The headlamp system of claim 7, wherein the second end position is adjustable to provide headlamp leveling of the light distribution.

9. The headlamp system of claim 7, wherein, when the headlamp is mounted in the motor vehicle, the light exit surface is positioned higher in the second end position than in the first end position in a vertical direction of the motor vehicle.

10. The headlamp system of claim 1, further comprising an additional light module including an additional light source and an additional optical system, the additional light module being fastened in the support frame, wherein the additional light source is activatable to emit light, and the additional optical system is configured to shape the emitted light and direct the light via an additional light exit surface toward the cover lens to produce an additional light distribution, wherein in the second end position the additional light exit surface is positioned within the region covered by the cover frame and is concealed from external view, and in the first end position the additional light exit surface is positioned outside the region covered by the cover frame and is visible from outside.

11. The headlamp system of claim 10, wherein the additional light source is activated in the first operating mode and deactivated in the second operating mode.

12. The headlamp system of claim 11, wherein the additional light module is a daytime running light module.

13. The headlamp system of claim 10, wherein the cover frame includes a light exit window, wherein in the first end position the additional light exit surface is positioned in the light exit window, and wherein in the second end position the light exit surface is positioned in the light exit window.

14. The headlamp system of claim 1, wherein the cover frame is completely opaque.

15. A motor vehicle comprising the headlamp system of claim 1.
